(19) United States
(12) Patent Application Publication
(10) Pub. No.: US 2026/0257816 A1
(43) Pub. Date: Sep. 3, 2026

(54) DRONE ATTRACTION SYSTEM AND METHOD

(71) Applicant: Universal City Studios LLC, Universal City, CA (US)

(72) Inventors: Byron C. Miller, Orlando, FL (US); Shannon Marie Ronquillo, Orlando, FL (US); Phillip Ben Burgos, Orlando, FL (US); Alec DiLiello, Orlando, FL (US)

(21) Appl. No.: 19/551,348

(22) Filed: Feb. 26, 2026

Related U.S. Application Data
(60) Provisional application No. 63/765,461, filed on Feb. 28, 2025.

(51) Int. Cl. B64U 40/20; B64U 10/13; B64U 101/00

(52) U.S. Cl. CPC B64U 40/20; B64U 10/13; B64U 2101/00; B64U 2201/10

(57) ABSTRACT

A system includes a drone having a propeller assembly, a motor assembly configured to drive the propeller assembly, at least one animated figure component, and at least one actuator coupled to the at least one animated figure component. The system also includes processing circuitry configured to control the motor assembly to drive the propeller assembly to cause a flight maneuver of the drone, control the at least one actuator to cause at least one movement of the at least one animated figure component, and coordinate the control of the motor assembly and the control of the at least one actuator to simulate a correspondence between the flight maneuver of the drone and the at least one movement of the at least one animated figure component.

### CROSS-REFERENCE TO RELATED APPLICATION

This application claims priority to and the benefit of U.S. Provisional Application No. 63/765,461, entitled “DRONE ATTRACTION SYSTEM AND METHOD,” filed February 28, 2025, which is incorporated by reference herein in its entirety for all purposes.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Entertainment venues, such as theme or amusement parks, have been created to provide guests with various immersive experiences. These entertainment venues may include various attractions, such as rides (e.g., rollercoasters), shows, games, and the like. A show, for example, may include drones controlled to provide one such immersive experience to the guests of the entertainment venue. Unfortunately, traditional configurations may include drones that lack features which would otherwise improve the immersive experience, are ill equipped for meeting drone regulatory standards, and/or are susceptible to failure. Accordingly, it is now recognized that improved systems and methods are desired.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from embodiments set forth below.

In an embodiment, a system includes a drone having a propeller assembly, a motor assembly configured to drive the propeller assembly, at least one animated figure component, and at least one actuator coupled to the at least one animated figure component. The system also includes processing circuitry configured to control the motor assembly to drive the propeller assembly to cause a flight maneuver of the drone, control the at least one actuator to cause at least one movement of the at least one animated figure component, and coordinate the control of the motor assembly and the control of the at least one actuator to simulate a correspondence between the flight maneuver of the drone and the at least one movement of the at least one animated figure component.

In an embodiment, one or more tangible, non-transitory, computer readable media includes instructions stored thereon that, when executed by a processing system having one or more processors, are configured to cause the processing system to perform various functions. The functions include controlling a motor assembly corresponding to a propeller assembly of a drone to cause a flight maneuver of the drone. The functions also include controlling at least one actuator corresponding to at least one animated figure component of the drone to cause at least one movement of the at least one animated figure component. The functions also include coordinating the control of the motor assembly and the control of the at least one actuator to simulate a correspondence between the flight maneuver of the drone and the at least one movement of the at least one animated figure component.

In an embodiment, a method includes controlling, via a control system, a motor assembly corresponding to a propeller assembly of a drone to cause a flight maneuver of the drone. The method also includes controlling, via the control system, at least one actuator corresponding to at least one animated figure component of the drone to cause at least one movement of the at least one animated figure component. The method also includes coordinating, via the control system, the control of the motor assembly and the control of the at least one actuator to simulate a correspondence between the flight maneuver of the drone and the at least one movement of the at least one animated figure component.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic overhead view of an embodiment of an entertainment venue having a drone attraction (e.g., a drone show) with drones employed therein, in accordance with an aspect of the present disclosure;

FIG. 2 is a perspective view of an embodiment of a portion (e.g., a skeleton, a frame, a structure) of a drone employed in the drone attraction of the entertainment venue illustrated in FIG. 1, in accordance with an aspect of the present disclosure;

FIG. 3 is a perspective view of an embodiment of a portion (e.g., a skeleton, a frame, a structure) of a drone employed in the drone attraction of the entertainment venue illustrated in FIG. 1, including a plurality of motor arrangements, in accordance with an aspect of the present disclosure;

FIG. 4 is a schematic underneath view of an embodiment of a drone employed in the drone attraction of the entertainment venue in FIG. 1, having the portion (e.g., the skeleton, the frame, the structure) of the drone in FIG. 3, and having various animated figure components such that the drone resembles an animated figure, in accordance with an aspect of the present disclosure;

FIG. 5 is a schematic side view of an embodiment of the drone in FIG. 4, in accordance with an aspect of the present disclosure;

FIG. 6 is a schematic front view of an embodiment of the drone in FIG. 4, in accordance with an aspect of the present disclosure;

FIG. 7 is a schematic block diagram illustrating an embodiment of a control assembly for operating the drone(s) of the drone attraction of the entertainment venue in FIG. 1, in accordance with an aspect of the present disclosure; and

FIG. 8 is a process flow diagram illustrating an embodiment of a method of operating the drone attraction of the entertainment venue in FIG. 1, in accordance with an aspect of the present disclosure; and

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to a drone attraction, such as a drone show, at an entertainment venue. More particularly, the present disclosure relates to coordination between flight maneuvers and animated figure components of a drone employed in the drone attraction, electrical hardware of the drone, and control procedures corresponding to multiple drones employed in the drone attraction.

A drone attraction, such as a drone show, may employ one or more drones, each drone resembling an animated figure. As an example, a drone in the drone attraction may resemble a flighted animal or creature, such as a bird. The drone may include various animated figure components corresponding to the flighted animal or creature (e.g., the bird), such as a mouth, a head, a neck, a pair of eyes, a pair of wings, a pair of legs, a tail, a torso, and/or the like. Further, each animated figure component may be movable via an actuator. As an example, one or more wing actuators may be employed to cause a flapping of the pair of wings of the drone. As another example, one or more head and/or neck actuators may be employed to cause a turning of the head and/or the neck of the drone.

The drone outlined above may also include a propulsion assembly, such as one or more propellers and one or more motors configured to drive the one or more propellers. For example, the propulsion assembly may include a bictoper propulsion assembly (e.g., including two propellers and two motors), a tricopter propulsion assembly (e.g., including three propellers and three motors), a quadcopter propulsion assembly (e.g., including four propellers and four motors), a pentacopter propulsion assembly (e.g., including five propellers and five motors), a hexacopter propulsion assembly (e.g., including six propellers and six motors), and/or the like. Any suitable number of propellers and motors may be employed at the propulsion assembly in accordance with the present disclosure. In general, each motor and propeller of the propulsion assembly may be controlled independently from the others to cause the drone to perform various flight maneuvers, such as an acceleration maneuver, a deceleration maneuver, a roll maneuver, a yaw maneuver, a pitch maneuver, a turning maneuver, a landing maneuver, a takeoff maneuver, and/or the like. That is, a first motor corresponding to a first propeller may be controlled to turn the first propeller at a first speed and/or in a first direction (e.g., clockwise direction), a second motor corresponding to a second propeller may be controlled to turn the second propeller at a second speed that may be different than the first speed and/or in a second direction (e.g., counterclockwise direction) that may be different than the first direction, and so on and so forth. In this way, complex flight maneuvers of the drone may be achieved.

In accordance with the present disclosure, a control system including one or more controllers may be configured to coordinate movement(s) of the animated figure component(s) via the actuator(s) with the flight maneuver(s) of the drone via the propulsion assembly. That is, control of the actuator(s) corresponding to the animated figure component(s) and the propulsion assembly of the drone may be coordinated to simulate a correspondence between the movement(s) of the animated figure component(s) and the flight maneuver of the drone. As one example, the wing actuator may be controlled to cause the flapping of the pair of wings of the animated figure corresponding to the drone at a higher right before or while the propulsion assembly is controlled to cause the drone to accelerate forward. In this way, the controls simulate a correspondence between the wings flapping at the higher rate and the drone accelerating forward, despite the wings not necessarily contributing to the acceleration of the drone forward. As another example, one or more head and/or neck actuators may be controlled to cause the head and/or the neck of the animated figure corresponding to the drone to turn in a rightwards and/or upwards direction before or while the propulsion assembly is controlled to cause the drone to move (e.g., turn) in the rightwards and/or upwards direction. In this way, the controls simulate a correspondence between the turning of the head and/or neck in the rightwards and/or upwards direction and the moving (e.g., turning) of the drone in the rightwards and/or upwards direction. Many other movements of the animated figure components of the animated figure corresponding to the drone and the flight maneuvers of the drone may be coordinated to simulate an effect, and will be described in greater detail with reference to the drawings. In some embodiments, the above-described controls (e.g., simulating the correspondence between the flight maneuver and the movement of an animated figure component) may be automated and referred to, for example, as an automated drone control protocol. In some embodiments, the above-described controls (e.g., simulating the correspondence between the flight maneuver and the movement of an animated figure component) may be based at least in part on manual control. In general, coordination between the movements of the animated figure component(s) via the actuator(s) and the flight maneuvers of the drone via the propulsion assembly may enhance, relative to tradition configurations, an immersive experience of guests observing the drone, for example, by giving the impression that the drone is a living, breathing creature.

As described above, multiple drones may employed in the drone attraction (e.g., drone show) in certain embodiments. In addition to the systems, methods, and techniques outlined above, presently disclosed embodiments may include a controls procedure for managing the multiple drones employed in the drone attraction to meet regulatory standards, ensure a smooth operation of the drone attraction, and/or reduce a likelihood of equipment loss or failure, among other technical benefits. For example, a geofence about a pre-defined flight area of the drone attraction may be implemented via Global Positioning System (GPS) technologies and/or other technologies (e.g., Real Time Kinematics or “RTK”), where the geofence is employed to block or a reduce a likelihood of a drone leaving the pre-defined flight area. In some embodiments, the pre-defined flight area is in a portion of the entertainment venue in which guests are not permitted to travel, thereby blocking or reducing a likelihood of interaction between the drones and the guests. Further, the geofence may be arranged about the pre-defined flight area such that a margin exists between the geofence and any areas of the entertainment venue that might be traveled by guests, as described in greater detail with reference to the drawings.

Further to the points above, each drone may be controlled (e.g., via manual control, automated control, and/or a hybrid of manual and automated control) toward various programmed or otherwise pre-defined waypoints distributed about the pre-defined flight area. Each waypoint may include an X, Y, and Z coordinate. In some embodiments, the various waypoints are programmed in a sequential or chronological order to cause the drone(s) to travel toward the various waypoints in the sequential or chronological order (e.g., toward a first waypoint, and then toward a second waypoint, and then toward a third waypoint, and so on and so forth). In certain embodiments, such as embodiments in which the waypoints are consistent between two drones, one of the two drones may be controlled to leave a launch pad of the drone attraction after the other of the two drones, such that the two drones travel along the same intended flight path, one after the other. Additionally or alternatively, in some embodiments, a first drone may be controlled toward waypoints that differ from those of a second drone, such that the flight paths of the first drone and the second drone differ. Control of the drones toward the waypoints may be based at least in part on sensor feedback indicative of environmental conditions in the pre-defined flight area, such as sensor feedback indicative of wind speed(s) from one or more anemometers, in addition to GPS and/or RTK sensor feedback.

Further still to the points above, the drone controls may include a procedure to account for circumstances where one or more of the drones deviate from intended flight paths and/or waypoints defining such intended flight paths. As an example, if a drone misses a waypoint by a threshold amount and/or deviates from the intended flight path by a threshold amount, a first step of the procedure may be employed in which manual intervention of the offending drone is attempted (e.g., to place the drone back on the intended flight path). If manual intervention for placing the drone on the intended flight path fails, a second step of the procedure may be employed in which the drone (and, in some embodiments, all other drones of the drone attraction) is automatically or manually returned to the launch pad. For example, in the second step of the procedure, a drone closest to the launch pad may be controlled back toward the launch pad while all other drones are controlled in a waiting pattern (e.g., held in place), and then, upon the first drone’s return to the launch pad, the next closest drone to the launch pad is controlled back toward the launch pad while the remaining drones are controlled in the waiting pattern, and so on and so forth. In some embodiments, the second step of the procedure may be employed in circumstances where sensor feedback (e.g., anemometer feedback) indicates that environmental conditions substantially change (e.g., a wind speed substantially increases, such as beyond a threshold wind speed) even if no drone has sufficiently deviated from the intended flight path and/or programmed waypoints.

If a drone leaves the pre-defined flight area defined by the geofence, a third step of the procedure may be employed in which power to the propulsion assembly of the drone at issue may be blocked (or some other mechanism for disabling the propulsion assembly may be controlled) to cause the drone to fall to ground. As previously described, the geofence may be positioned about the pre-defined flight area such that a margin exists between the geofence and any areas of the entertainment venue that might be traveled by guests. In this way, should the third step of the procedure be implemented, the drone will fall to ground in the margin and not within any areas of the entertainment venue that might be traveled by guests. While “first step,” “second step,” and “third step” are used to refer to aspects of the procedure above, it should be understood that the steps are not necessarily contingent on each other and/or in chronological order for all embodiments That is, “first step,” “second step,” and “third step” should not be taken to mean a sequence or chronology of the procedure in all embodiments of the present disclosure, although the procedure may include the first step, the second step, and the third step in sequential or chronological order in certain embodiments.

Presently disclosed embodiments may include, in addition to the systems, methods, and techniques described above, various electrical hardware configured to reduce failure modes of the drones individually and/or the drone attraction (e.g., drone show) as a whole. For example, each drone employed in the drone attraction may include an on-board printed circuit board (PCB) with processing circuitry (e.g., a processor), redundant processing circuitry (e.g., a redundant processor) in case the processing circuitry fails, communication circuitry (e.g., a receiver, a transmitter, and/or a transceiver), redundant communication circuitry (e.g., a redundant receiver, a redundant transmitter, and/or a redundance transceiver), and/or the like. Other componentry and redundant componentry (e.g., a battery and a redundant battery) may also be employed. The electrical hardware will be described in greater detail with reference to the drawings.

In general, presently disclosed embodiments enable various technical benefits over traditional configurations, including an improved immersive experience for guests attending or observing the drone attraction, smoother and/or more efficient operation of the drone attraction as a whole, and/or reduced likelihood of equipment failure or loss, among other technical benefits. These and other aspects of the present disclosure are described in detail below with reference to the drawings.

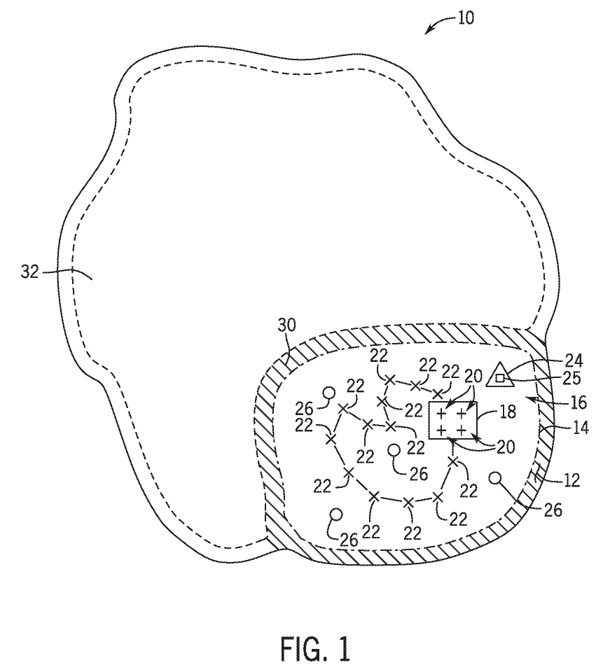

Continuing now to the drawings, FIG. 1 is a schematic overhead view of an embodiment of an entertainment venue 10 having a drone attraction 12 (e.g., a drone show). In the illustrated embodiment, the drone attraction 12 includes a geofence 14 disposed about a pre-defined flight area 16. Maintenance and/or controlled enforcement of the geofence 14 may be implemented via Global Positioning System (GPS) technologies and/or other technologies (e.g., Real Time Kinematics, also referred to as “RTK”), as described in greater detail with reference to later drawings.

As shown in FIG. 1, a launch pad 18 may be disposed within the pre-defined flight area 16. Various drones 20 included in the drone attraction 12 may take off from the launch pad 18 and return to the launch pad 18 after a flight routine. While four drones 20 are illustrated in FIG. 1, it should be understood that any suitable number of drones 20 may be included in the drone attraction 12. In some embodiments, flight paths of the drones 20 are defined or otherwise controlled by way of waypoints 22 distributed about the pre-defined flight area 16. The drones 20, for example, may be programmed or otherwise controlled to fly toward and between the waypoints 22, where each waypoint 22 corresponds to a location having an X-coordinate, a Y-coordinate, and/or a Z-coordinate. In some embodiments, each drone 20 includes an on-board processing system programmable to travel to the waypoints 22 in, for example, a pre-defined, sequential, or chronological order. Such programming may be input directly to the on-board processing unites of each drone 20, or via a separate controller 25 (e.g., a remote controller) disposed, for example, at a control room 24 corresponding to the drone attraction 12 (e.g., via a wired or wireless communicative coupling between the controller 25 and each drone 20). In this and/or other ways, programming and/or in-flight control of the drones 20 may include fully automated control (e.g., an automated drone control protocol), fully manual control, or hybrid automated-manual control, depending on the embodiment.

In some embodiments, environmental sensors 26 may be distributed about the pre-defined flight area 16 and configured to provide, to each drone 20 and/or to the controller 25, environmental feedback that might impact flight controls. As an example, the environmental sensors 26 may include anemometers configured to provide wind speed and/or wind direction feedback to the drones 20 and/or the controller 25. Other environmental sensors 26 are also possible, such as rain sensors, moisture sensors, temperature sensors, etc.

Control of the drones 20 in the drone attraction 12 may include a procedure for handling circumstances where one or more of the drones 20 deviates from a programmed or otherwise intended flight path. As an example, if one of the drones 20 deviates from one of the waypoints 22 (or from a flight path between adjacent or sequential waypoints 22) by more than a threshold amount, a first step of the procedure may be implemented. In the first step of the procedure, manual intervention to place the drone 20 back on the intended flight path (or to a particular waypoint 22) may be attempted. If manual intervention at the first step fails, a second step of the procedure may be implemented. In the second step, all of the drones 20 in-flight may be controlled to a holding pattern, except for the drone 20 closest to the launch pad 18, which may be controlled to fly back to the launch pad 18 (e.g., via the shortest unobstructed path to the launch pad 18). Once the closest drone 20 is returned to the launch pad 18, the next closest drone 20 is returned to the launch pad 18 (e.g., via the shortest unobstructed path to the launch pad 18), while the remaining drones 20 still in-flight are maintained in the holding pattern. The second step may be iterated until all of the drones 20 are returned to the launch pad 18. Additionally or alternatively, if one of the drones 20 exits the pre-defined flight area 16 (i.e., outside of the geofence 14), a third step of the procedure may be implemented in which power to a propulsion assembly of the drone 20 may be disabled (or the propulsion assembly may be disabled via triggering of some other control function) to cause the drone 20 to fall to ground. As shown, a gap 30 may be defined between the geofence 14 and areas 32 of the entertainment venue 10 that might be traveled by guests. In this way, the third step of the procedure causes the drone 20 to fall into the gap 30 and not into the areas 32 of the entertainment venue 10 that might be traveled by guests.

Each drone 20 may include a propulsion assembly including (or otherwise driven by) a motor assembly to cause various flight maneuvers of the drone 20. For example, the drone 20 may be controlled to turn in a rightwards direction, a leftwards direction, an upwards direction, a downwards direction, or a combination thereof. Additionally or alternatively, the drone 20 may be controlled to roll, pitch, and/or yaw. Additionally or alternatively, the drone 20 may be controlled to accelerate or decelerate. Additionally or alternatively, the drone 20 may be controlled to take off (e.g., from the launch pad 18) and land (e.g., on the launch pad 18).

Further, each drone 20 may include one or more animated figure components movable via one or more corresponding actuators. For example, the drone 20 may include various features that cause the drone 20 to resemble a flighted creature or animal (e.g., a bird), such as wings, a tail, a head, a neck, a mouth, one or more appendages (e.g., legs), a torso, and the like. In accordance with the present disclosure, the actuators may be controlled to cause movements of the one or more animated figure components such that the movements coincide with the flight maneuvers of the drones 20. As an example, the wings of the drone 20 may be controlled to a faster flapping rate as the drone 20 is controlled to accelerate forwards. Additionally or alternatively, the flapping rate may be controlled to correspond to a speed of the drone 20. As another example, the head and/or neck of the drone 20 may be controlled to move in a rightwards direction before or while the drone 20 is controlled to turn in the rightwards direction. In this way, control of the flight path of the drone 20 and control of the movement of the animated figure component is coordinated to simulate a correspondence between the flight path and the movement of the animated figure component, improving an immersive experience of guests observing the drone attraction 12. In some embodiments, on-board processing and/or control units of the drones 20 include various redundant components that improve a reliability of flight maneuver control, animated figure component control, and coordination there between. These and other aspects of the present disclosure are described in greater detail below with reference to later drawings.

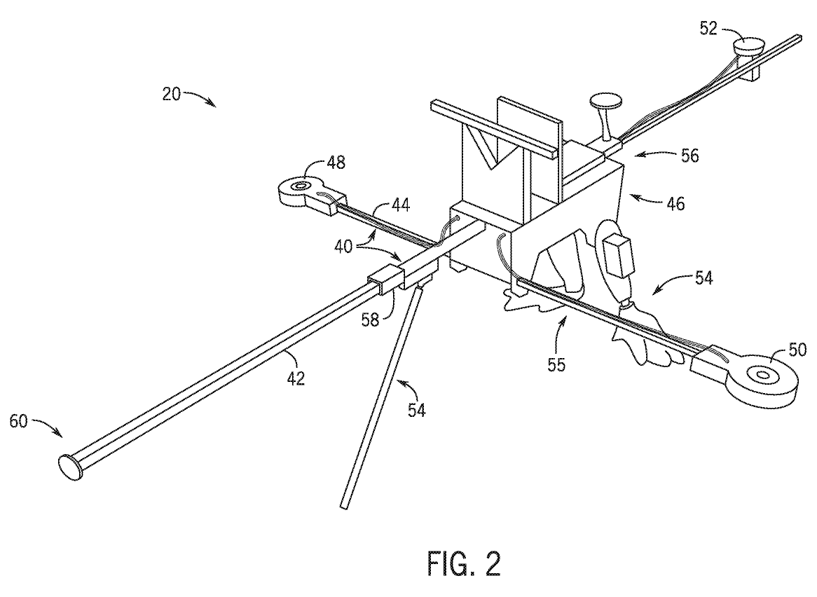

FIG. 2 is a perspective view of an embodiment of a portion (e.g., a skeleton, a frame, a structure) of one of the drones 20 employed in the drone attraction 12 of the entertainment venue 10 illustrated in FIG. 1. In the illustrated embodiment, the drone 20 includes a frame 40 (e.g., airframe) having at least one length member 42 and at least one width member 44, where the at least one width member 44 extends transverse to (e.g., perpendicular to) the at least one length member 42. In some embodiments, the at least one length member 42 includes multiple members coupled together and/or the at least one width member 44 includes multiple members coupled together.

As shown, an electronics assembly 46 is coupled to the frame 40 and may include, among other possible componentry, batteries, GPS hardware, RTK hardware, sensors, processing circuitry, memory circuitry, and/or communications circuitry (e.g., a receiver, a transmitter, a transceiver). In some embodiments, the electronics assembly 46 overlaps with a center of mass and/or center of gravity of the frame 40, which may improve a balance of the drone 20 in certain embodiments and/or conditions. As shown, the drone 20 also includes at least two motors 48, 50 disposed on (or otherwise integrated with) the width member 44 (e.g., at opposing ends of the width member 44). Further, the drone 20 includes at least one motor 52 disposed on (or otherwise integrated with) the length member 42. In general, the motors 48, 50, 52 are configured to drive propellers (not shown) of the drone 20 to control a flight path of the drone 20. The motors 48, 50, 52 (and, thus, the corresponding propellers) may be controllable independent and/or in coordination with one another. As an example, the motor 48 may be controlled at a first speed and in a first direction and the motor 50 may be controlled at a second speed and in a second direction simultaneously, where the first speed differs from the second speed, the first direction differs from the second direction, or both, based on an intended flight maneuver of the drone 20. While the illustrated embodiment includes three motors 48, 50, 52, it should be understood that any suitable number of motors and corresponding propellers may be employed depending on the embodiment.

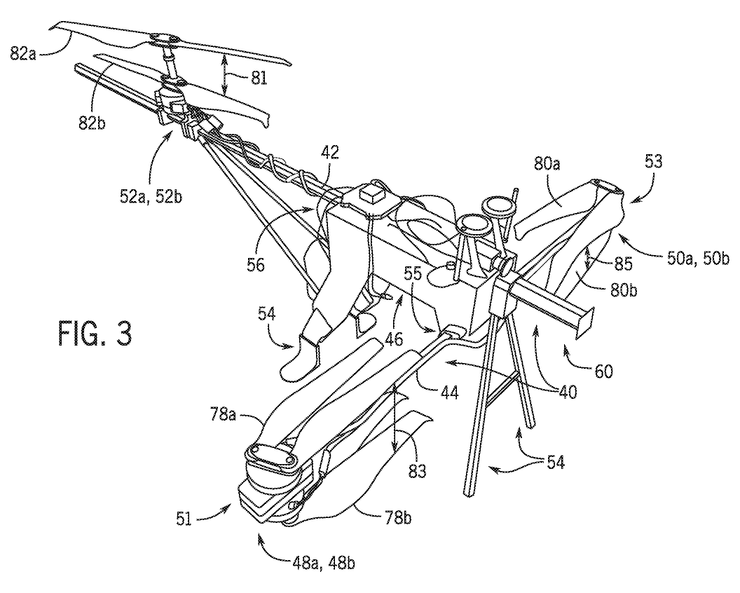

The drone 20 also includes landing gear 54 to facilitate a landing of the drone 20 and various actuators configured to actuate various animated figure components that, while not shown in totality in FIG. 2, may be disposed on or otherwise integrated with the frame 40 of the drone 20. As an example, the frame 40 of the drone 20 in FIG. 2 includes at least one wing pivot 55 (e.g., wing actuator, such as a motor or other actuation mechanism) configured to cause a movement of a wing of the drone 20, at least one tail pivot 56 (e.g., tail actuator) configured to cause a movement of a tail of the drone 20, at least one head and/or neck pivot 58 (e.g., head and/or neck actuator, such as a motor or other actuation mechanism) configured to cause a movement of a head and/or neck of the drone 20, and at least one mouth pivot 60 (e.g., mouth actuator, such as a motor or other actuation mechanism) configured to cause a movement of a mouth of the drone 20. As previously described, and as described in greater detail below with reference to FIGS. 3-6, control of the various pivots 56, 58, 60 (e.g., actuators, such as motors or other actuation mechanism) may be coordinated with control of the motors 48, 50, 52 to simulate a correspondence between the movement(s) of the animated figure component(s) of the drone 20 and the flight maneuver(s) of the drone 20.

In some embodiments, the drone 20 may include additional motors and/or propellers. For example, FIG. 3 is a perspective view of an embodiment of the drone 20 including various motor arrangements. In the illustrated embodiment, the drone 20 includes certain of the same or similar features set forth above with respect to FIG. 2. However, the drone 20 in FIG. 3 may include a first motor arrangement including a first motor 48a and an additional first motor 48b disposed on a first end 51 of the width member 44, a second motor arrangement including a second motor 50a and an additional second motor 50b disposed on a second end 53 of the width member 44 opposing the first end 51 of the width member 44, and a third motor arrangement including a third motor 52a and an additional third motor 52b disposed on the length member 42. In certain embodiments of the present disclosure, at least one motor arrangement, such as the third motor arrangement including the third motor 52a and the additional third motor 52b, is a co-axial motor arrangement. For example, the third motor 52a and the additional third motor 52b may be disposed on a common axis and/or may drive respective propellers, described in greater detail below, in opposing directions (e.g., to increase lift, efficiency, and/or stability) in at least certain operating conditions. While the third motor arrangement is described above as being a co-axial motor arrangement in certain embodiments of the present disclosure, it should be understood that the first motor arrangement and/or the second motor arrangement also may be co-axial motor arrangements in certain embodiments.

As shown in FIG. 3, the first motor 48a may be configured to drive a propeller 78a, the additional first motor 48b may be configured to drive an additional first propeller 78b, the second motor 50a may be configured to drive a second propeller 80a, the additional second motor 50b may be configured to drive an additional second propeller 80b, the third motor 52a may be configured to drive a third propeller 82a, and the additional third motor 52b may be configured to drive an additional third propeller 82b. In some embodiments, each motor of each motor arrangement is capable of being independently controlled. Additionally or alternatively, in some embodiments, motors corresponding to a particular motor arrangement may be controlled in coordination with one another to generate desirable lift and/or flight maneuvers (e.g., roll, pitch, yaw, etc.).

In the illustrated embodiment, the third motor 52a, the third propeller 82a, the additional third motor 52b, and the additional third propeller 82b are disposed on (or along) a common side of the drone 20, such as a side opposing the landing gear 54. For example, the third motor 52a, the third propeller 82a, the additional third motor 52b, and the additional third propeller 82b may be disposed on (or along) a top of the length member 42. Additionally or alternatively, the first motor 48a, the first propeller 78a, the second motor 50a, and the second propeller 80a may be disposed on (or along) a common side of the drone 20, such as a side opposing the landing gear 54. For example, the first motor 48a, the first propeller 78a, the second motor 50a, and the second propeller 80a may be disposed on (or along) a top of the width member 44. Additionally or alternatively, the additional first motor 48b, the additional first propeller 78b, the additional second motor 50b, and the additional second propeller 80b may be disposed on (or along) a common side of the drone 20, such as a side from which the landing gear 54 extends. For example, the additional first motor 48b, the additional first propeller 78b, the additional second motor 50b, and the additional second propeller 80b may be on (or along) a bottom of the width member 44.

In certain aspects of the present disclosure, the motors 48a, 48b, 50a, 50b, 52a, 52b may be referred to as a motor assembly, and the propellers 78a, 78b, 80a, 80b, 82a, 82b may be referred to as a propeller assembly or propulsion assembly. In certain embodiments and/or conditions, the motor arrangements (and related features) described above may improve a flight stability and/or flight efficiency of the drone 20, may enable more desirable (e.g., flexible) theming (e.g., costuming, animations, etc.) of the drone 20, or both relative to traditional configurations. Additionally or alternatively, a spacing between propellers (e.g., of a propeller pair) may be selected based on torque requirements and/or optimization, to block a counterflow of air between adjacent propellers (e.g., of a propeller pair) from negatively impacting flight dynamics, or both. For example, a distance 81 between the third propeller 82a and the additional third propeller 82b may be between 75 millimeters (mm) and 90 mm, or between 80 and 85 mm. Further, a distance 83 between the first propeller 78a and the additional first propeller 78b may be between 120 mm and 140 mm, or between 125 mm and 135 mm. Further still, a distance 85 between the second propeller 80a and the additional second propeller 80a may be between 120 mm and 140 mm, or between 125 mm to 135 mm. In some embodiments, the distance 83 may be substantially equal to the distance 85.

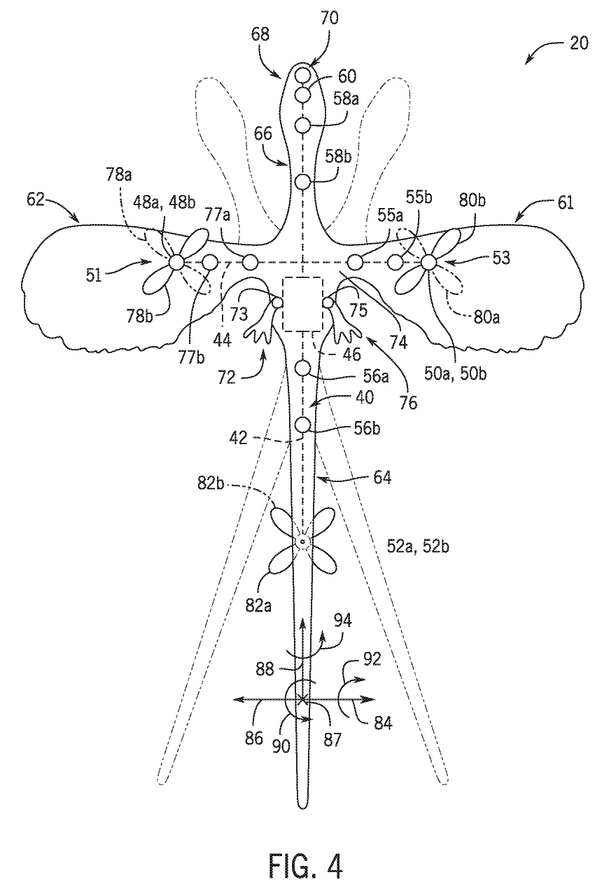

FIG. 4 is a schematic underneath view of an embodiment of the drone 20 employed in the drone attraction 12 of the entertainment venue 10 in FIG. 1, having the frame 40 of the drone 20 in FIG. 3, and having various animated figure components such that the drone 20 resembles an animated figure, such as an animated creature or animal (e.g., a bird). For example, the animated figure components include a first wing 61 integrated with the width member 44, a second wing 62 integrated with the width member 44 and opposing the first wing 61 across the length member 42, a tail 64 integrated with the length member 42, a neck 66 integrated with the length member 42, a head 68 integrated with the length member 42, a mouth 70 disposed on the head 68, a first leg 72 (and/or foot) extending from a torso 74, and/or a second leg 76 (and/or foot) extending from the torso 74. In some embodiments, the neck 66 and the head 68 may be a single (e.g., integrated) controllable animated figure component. Other animated component features may include a speaker configured to output noise, a pyrotechnic feature configured to output fire, and the like.

As shown, various pivots (e.g., actuators, such as motors or other actuation mechanisms) may be controlled to cause various movements of the animated figure components. For example, two wing pivots 55a, 55b may be employed to move the first wing 61, leg pivots 73, 75 may be employed to move (e.g., extend, retract, turn, etc.) the legs 72, 76, respectively, two additional wing pivots 77a, 77b may be employed to move the second wing 62, two tail pivots 56a, 56b may be employed to move the tail 64, two head and/or neck pivots 58a, 58b may be employed to move the head 68 and/or the neck 66, and the mouth pivot 60 may be employed to move the mouth 70. In instances of the illustrated embodiment where two pivots are employed for a single animated figure component, it should be understood that a different number of pivots (e.g., one pivot) may be employed for the corresponding animated figure component in another embodiment. However, including multiple pivots, such as the two tail pivots 56a, 56b, may enable an articulated and/or more realistic movement of the corresponding animated figure component, such as the tail 64.

Also shown in the illustrated embodiment are the motors 48a, 48b, 50a, 50b, 52a, 52b. Corresponding propellers 78a, 78b, 80a, 80b, 82a, 82b (e.g., propellers) may be driven by the motors 48a, 48b, 50a, 50b, 52a, 52b respectively, to cause various flight maneuvers of the drone 20. For example, the motors 48a, 48b, 50a, 50b, 52a, 52b may be controlled to drive the propellers 78a, 78b, 80a, 80b, 82a, 82b (e.g., propellers) to turn the drone 20 in a rightwards direction 84 and/or a leftwards direction 86 opposing the rightwards direction 84. Additionally or alternatively, the motors 48a,, 48b, 50a, 50b, 52a, 52b may be controlled to drive the propellers 78a, 78b, 80a, 80b, 82a, 82b (e.g., propellers) to lift or lower the drone 20 along a vertical direction 87. Additionally or alternatively, the motors 48a, 48b, 50a, 50b, 52a, 52b may be controlled to drive the propellers 78a, 78b, 80a, 80b, 82a, 82b (e.g., propellers) to cause an acceleration of the drone 20 in a forwards direction 88 and/or to cause a deceleration of the drone 20 along the forwards direction 88. Additionally or alternatively, the motors 48a, 48b, 50a, 50b, 52a, 52b may be controlled to drive the propellers 78a, 78b, 80a, 80b, 82a, 82b (e.g., propellers) to cause a yaw maneuver 90 of the drone 20, to cause a pitch maneuver 92 of the drone 20, and/or to cause a roll maneuver 94 of the drone 20, as shown. Other flight maneuvers are also possible. Any movements of the animated figure components disclosed herein may be controlled to correspond to (e.g., occur in time or adjacent in time) any flight maneuver of the drone 20 described herein to simulate a correspondence between the movement(s) of the animated figure component(s) and the flight maneuver of the drone 20. As merely two examples illustrated in FIG. 4, a movement of the neck 66 and/or the head 68 (e.g., in the rightwards direction 84) may be coordinated with a turning of the drone 20 (e.g., in the rightwards direction 84), and a movement of the tail 64 (e.g., in the rightwards direction 84) may be coordinated with a turning of the drone 20 (e.g., in the rightwards 84 or the leftwards direction 86).

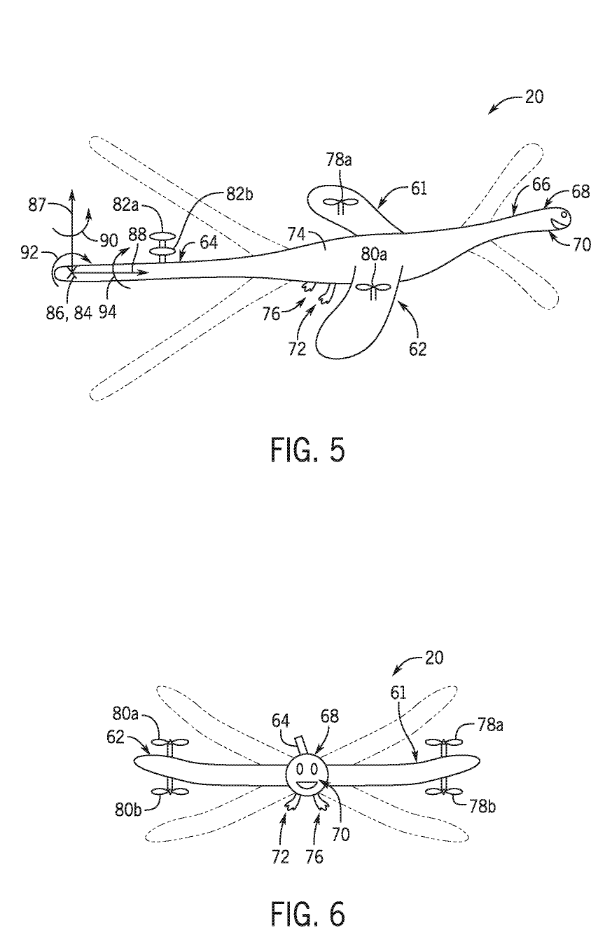

FIG. 5 is a schematic side view of an embodiment of the drone 20 in FIG. 4. While movement of the neck 66, the head 78, and the tail 64 are illustrated in FIG. 3 in the rightwards direction 84 and the leftwards direction 86, FIG. 5 illustrates movement of the head 68, the neck 66, and the tail 64 along the vertical direction 87 (e.g., up and down). Articulation (e.g., movement) of the head 68, the neck 66, and/or the tail 64 along the vertical direction 87 (e.g., up and down) may be controlled to correspond, for example, with a lifting or a lowering of the drone 20 and/or a turning of the drone 20 along the vertical direction 87 (e.g., up and down), or with any other suitable flight maneuver of the drone 20.

FIG. 6 is a schematic front view of an embodiment of the drone 20 showing that a flapping of the wings 61, 62 may be controlled. For example, an increase in a flapping rate of the wings 61, 62 may be implemented to correspond with an acceleration of the drone 20 (or a higher speed of the drone 20) and/or a decrease in the flapping rate of the wings 61, 62 may be implemented to correspond with a deceleration of the drone 20 (or a lower speed of the drone 20). It should be understood that certain embodiments of the drone 20 in FIGS. 5 and 6 may include the same or similar motor arrangements and/or propellers illustrated in, and described above with respect to, FIGS. 3 and 4, although not all such motor arrangements and/or propulsion assemblies are shown in FIGS. 5 and 6 due to the illustrated perspective and/or theming (e.g., costuming) of the drone 20.

As described above with respect to FIGS. 3-6, the drone 20 may be controlled to cause a coordination between one or more flight maneuvers and one or more movements of the animated figure components. Such flight maneuvers may include, for example, a lifting of the drone 20, a lowering of the drone 20, a takeoff of the drone 20, a landing of the drone 20, a turning of the drone 20 in one or more directions, a roll of the drone 20, a pitch of the drone 20, a yaw of the drone 20, an acceleration of the drone 20, a deceleration of the drone 20, and/or other flight maneuvers. Such movements of the animated figure components may include, for example, a movement of the head 68, the neck 66, and/or the tail 64 in one or more directions, an increase and/or decrease in a flapping rate of the wings 61, 62, an opening and/or a closing of the mouth 70, an extension and/or retraction (or other movement, such as a turning) of one or more appendages, such as the legs 72, 76, and the like. While specific pairings of flight maneuver and animated figure component movement are described above, any suitable pair of flight maneuver and animated figure component movement may be coordinated to simulate a realistic effect of the animated figure (e.g., flying creature or animal, such as a bird) in accordance with the present disclosure.

While various examples of the drone 20 are provided in FIGS. 2-6 above, it should be understood that other types of the drone 20 are also possible. For example, each drone 20 may include a different aesthetic (e.g., a first type or species of bird, a second type or species of bird different than the first type of bird, etc.). Further, certain drones 20 may have different propellers than those illustrated in FIGS. 2-6. For example, one or more of the drones 20 may include a ducted in-line fan or turbine configuration.

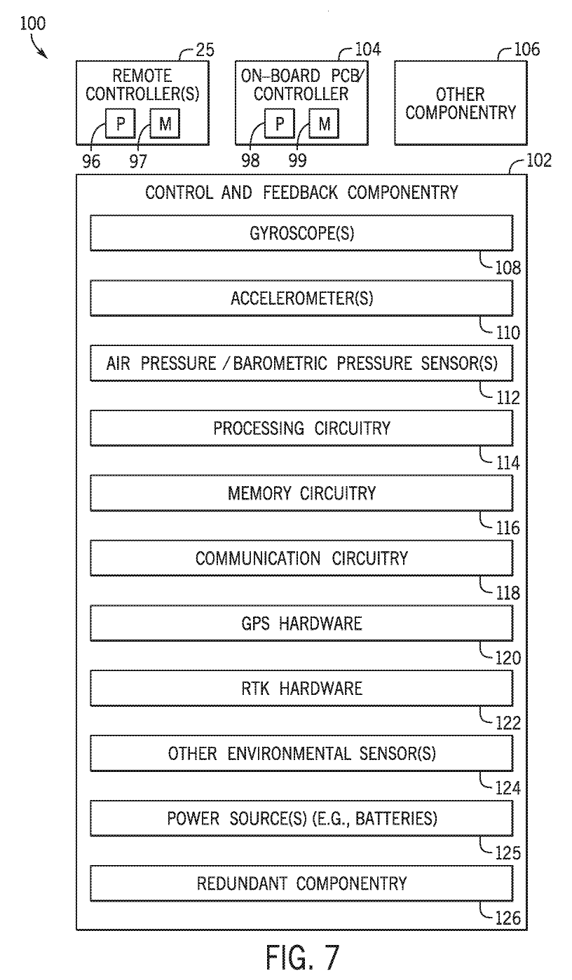

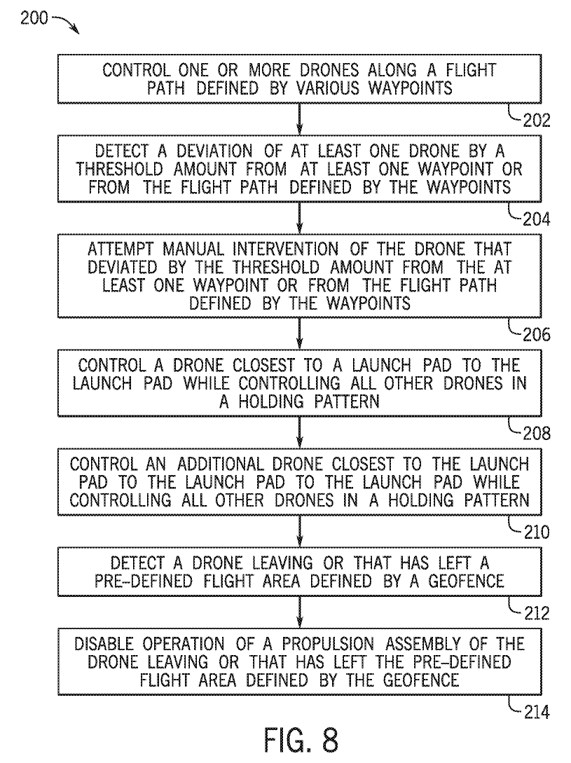

FIG. 7 is a schematic block diagram illustrating an embodiment of a control assembly 100 for operating the drone(s) 20 of the drone attraction 12 of the entertainment venue 10 in FIG. 1. For example, various aspects of the control assembly 100 may be employed to control flight maneuvers of the drone(s) 20, movement of the animated components of the drone(s) 20, coordination between the flight maneuvers and movement of the animated components, coordination of the movement between the various drone(s) 20 in a show, and/or movement of the drone(s) 20 when one or more of the drone(s) deviate from an intended path, as described in detail above with respect to FIGS. 1-6 and/or below with respect to FIG. 8. As shown, the control assembly 100 in the illustrated embodiment may include the controller 25 (e.g., remote controller), where the controller 25 includes processing circuitry 96 and memory circuitry 97 (and, in some embodiments, communications circuitry, such as a transmitter, a receiver, and/or a transceiver). Further, the control assembly 100 may include various control and feedback componentry 102 that may be distributed about various aspects of the drone attraction 12, such as the one or more remote controllers 25 (e.g., disposed at the control room 24 in FIG. 1), on-board PCB/controllers 104 (e.g., disposed on the drones 20 in FIG. 1) including processing circuitry 98 and memory circuitry 99 (and, in some embodiments, communications circuitry, such as a transmitter, a receiver, and/or a transceiver), and other componentry 106 (e.g., disposed somewhere other than the one or more remote controllers 25 and the on-board PCB/controllers 104). Any suitable distribution of the control and feedback componentry 102 between the remote controller(s) 25, the on-board PCB/controller(s) 104, and the other componentry 106 may be employed in the drone attraction 12 of the entertainment venue 10 in FIG. 1. Further, the control and feedback componentry 102 illustrated in FIG. 7 and described below should not be taken as necessarily comprehensive, as other control and feedback componentry is also possible.

As shown, the control and feedback componentry 102 may include one or more gyroscopes 108, one or more accelerometers 110, one or more air pressure (or barometric pressure) sensors 112, processing circuitry 114, memory circuitry 116 storing instructions (e.g., an automated drone control protocol) executable by the processing circuitry 114 to perform various functions (e.g., control flight maneuvers and animated figure component controls), communication circuitry 118 (e.g., configured to enable transmission and/or receipt of wired and/or wireless signals, such as one or more receivers, one or more transmitters, and/or one or more transceivers), GPS hardware and/or software 120, RTK hardware and/or software 122, other environmental sensors 124 (e.g., anemometers), and/or one or more power sources 125 (e.g., batteries). Further, in certain embodiments, the control and feedback componentry 102 includes redundant componentry 126 of any one or more of the aforementioned components 108, 110, 112, 114, 116, 118, 120, 122, 124, 125. For example, the redundant componentry 126 may operate to provide backup controls and/or feedback in the event any of the aforementioned components 108, 110, 112, 114, 116, 118, 120, 122, 124, 125 fails.

It should be understood that any instance of memory circuitry (e.g., memory circuitry 97, 99, 116) described above may include instructions stored thereon that, when executed by a respective instance of processing circuitry (e.g., processing circuitry 96, 98, 114), causes the respective control component (e.g., controller) to perform various functions. For example, the memory circuitry may include one or more memories, such as volatile memory (e.g., random-access memory or RAM) and/or non-volatile memory, such as read-only memory (ROM), optical drives, hard disc drives, solid-state drives, or any other non-transitory computer-readable medium that includes instructions (e.g., processor input instructions) to perform various functions, or any combination thereof. The processing circuitry may include one or more application specific integrated circuits (ASICs), one or more field programmable gate arrays (FPGAs), one or more general purpose processors, or the like, or any combination thereof.

FIG. 8 is a process flow diagram illustrating an embodiment of a method 200 of operating the drone attraction 12 of the entertainment venue 10 in FIG. 1. In the illustrated embodiment, the method 200 includes, for example, a procedure by which the drones 20 in the drone attraction 12 of the entertainment venue 10 deviate from intended flight paths. An order of the steps of the method 200 illustrated in FIG. 8 and described in detail below should not be taken as necessarily implying a chronology of the steps of the method 200 in all embodiments, although the order of the steps of the method 200 illustrated in FIG. 8 and described in detail below may be chronological in one embodiment of the present disclosure. Further, it should be understood that certain steps of the method 200 illustrated in FIG. 8 and described in detail below may be excluded in certain embodiments of the method 200, and that additional steps not illustrated in FIG. 8 and/or not described in detail below may be included in certain embodiments of the method 200. The steps of the method 200 illustrated in FIG. 8 and described in detail below are merely exemplary of one embodiment of the method 200 in accordance with the present disclosure.

As shown, the method 200 includes controlling (block 202) one or more drones along a flight path (e.g., pre-defined flight path) defined by various waypoints. Such control may include, but is not limited to, controlling various flight maneuvers of the drone and various animated figure components of the drone to coordinate the flight maneuvers with movements of the animated figure components, as previously described.

Further, the method 200 includes detecting (block 204) a deviation of at least one drone from at least one waypoint or from the flight path defined by the waypoints by at least a threshold amount. For example, the deviation may be detected by GPS and/or RTK hardware integrated at least in part with the drone. The method 200 also includes attempting (block 206) manual intervention of the drone that deviated by the threshold amount from the at least one waypoint or from the flight path defined by the waypoints. For example, while the waypoints, flight paths, flight maneuvers, and/or the animated figure components control may be at least partially automated (e.g., pre-programmed), manual intervention may be attempted when a drone deviates from the automated (e.g., pre-programmed) controls. If manual intervention is successful, the drone attraction may proceed with the automated (e.g., pre-programmed) controls in certain embodiments. If manual intervention fails, the method 200 may proceed to block 208 described below.

The method 200 also includes (e.g., in response to a failure of manual intervention at block 204) controlling (block 208) a drone closest to a launch pad to the launch pad while controlling all other drones (e.g., in-flight drones) in a holding pattern. For example, the drone closest to the launch pad may be controlled along a shortest flight path that does not overlap with a position of any of the drones being controlled in the holding pattern. The method 200 also includes (e.g., after the above-described drone reaches the launch pad) controlling (block 210) an additional drone closest to the launch pad to the launch pad while the other drones are controlled in the holding pattern. This procedure may be repeated until all drones are safely returned to the launch pad.

The method 200 also includes detecting (block 212) a drone leaving or that has left a pre-defined flight area defined by a geofence. For example, enforcement of the geofence may be based on GPS hardware and/or RTK hardware, as previously described. The drone may leave the pre-defined flight area in a runaway condition. In response to the drone leaving the pre-defined flight area, the method 200 includes disabling (block 214) operation of a propulsion assembly (e.g., including a motor assembly) of the drone such that the drone falls to ground. The geofence may be defined a sufficient distance (e.g., a gap) away from other areas of the entertainment venue that might be traveled by guests. In this way, the drone leaving the pre-defined flight area will fall to ground in an area of the entertainment venue that is not traveled by guests.

While only certain features have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A system comprising:
a drone having a propeller assembly, a motor assembly configured to drive the propeller assembly, at least one animated figure component, and at least one actuator coupled to the at least one animated figure component; and
processing circuitry configured to:
control the motor assembly to drive the propeller assembly to cause a flight maneuver of the drone;
control the at least one actuator to cause at least one movement of the at least one animated figure component; and
coordinate the control of the motor assembly and the control of the at least one actuator to simulate a correspondence between the flight maneuver of the drone and the at least one movement of the at least one animated figure component.

2. The system of claim 1, wherein the at least one animated figure component comprises a head or neck.

3. The system of claim 2, wherein the at least one movement of the at least one animated figure component comprises a head or neck movement of the head or neck in a direction, and the flight maneuver comprises a turning of the drone toward the direction.

4. The system of claim 1, wherein the at least one animated figure component comprises a wing.

5. The system of claim 4, wherein the at least one movement of the at least one animated figure component comprises an increase in a flapping rate of the wing, and the flight maneuver comprises an acceleration of the drone.

6. The system of claim 1, wherein the flight maneuver comprises a roll of the drone, a yaw of the drone, or a pitch of the drone.

7. The system of claim 1, wherein the at least one animated figure component comprises an appendage, a torso, or both.

8. The system of claim 1, wherein:
the motor assembly comprises at least one first motor, at least one second, and at least one third motor; and
the propeller assembly comprises a first propeller and an additional first propeller configured to be driven by the at least one first motor, a second propeller and an additional second propeller configured to be driven by the at least one second motor, and a third propeller and an additional third propeller configured to be driven by the at least one third motor.

9. The system of claim 8, wherein the at least one first motor comprises a motor configured to drive the first propeller and an additional motor configured to drive the additional first propeller, and the motor and the additional motor are disposed in a co-axial motor arrangement.

10. The system of claim 1, comprising memory circuitry storing an automated drone control protocol thereon, wherein the processing circuitry is configured to execute the automated drone control protocol to:
control the motor assembly to drive the propeller assembly to cause the flight maneuver of the drone;
control the at least one actuator to cause the at least one movement of the at least one animated figure component; and
coordinate the control of the motor assembly and the control of the at least one actuator to simulate the correspondence between the flight maneuver of the drone and the at least one movement of the at least one animated figure component.

11. One or more tangible, non-transitory, computer readable media comprising instructions stored thereon that, when executed by a processing system comprising one or more processors, are configured to cause the processing system to:
control a motor assembly corresponding to a propeller assembly of a drone to cause a flight maneuver of the drone;
control at least one actuator corresponding to at least one animated figure component of the drone to cause at least one movement of the at least one animated figure component; and
coordinate the control of the motor assembly and the control of the at least one actuator to simulate a correspondence between the flight maneuver of the drone and the at least one movement of the at least one animated figure component.

12. The one or more tangible, non-transitory, computer readable media of claim 11, wherein the at least one movement of the at least one animated figure component includes a head or neck movement of a head or neck corresponding to the at least one animated figure component in a direction, and the flight maneuver includes a turning of the drone in the direction.

13. The one or more tangible, non-transitory, computer readable media of claim 11, wherein the at least one movement of the at least one animated figure component includes an increase in a flapping rate of a wing corresponding to the at least one animated figure component, and the flight maneuver includes an acceleration of the drone.

14. The one or more tangible, non-transitory, computer readable media of claim 11, wherein the flight maneuver includes a roll of the drone, a yaw of the drone, or a pitch of the drone.

15. The one or more tangible, non-transitory, computer readable media of claim 11, wherein the flight maneuver includes a landing of the drone or a takeoff of the drone.

16. The one or more tangible, non-transitory, computer readable media of claim 15, wherein the at least one movement of the at least one animated figure component includes an extension or retraction of an appendage.

17. The one or more tangible, non-transitory, computer readable media of claim 11, wherein the at least one movement of the at least one animated figure component includes a tail movement of a tail corresponding to the at least one animated component, an opening or a close of a mouth corresponding to the at least one animated component, or any combination thereof.

18. A method comprising:
controlling, via a control system, a motor assembly corresponding to a propeller assembly of a drone to cause a flight maneuver of the drone;
controlling, via the control system, at least one actuator corresponding to at least one animated figure component of the drone to cause at least one movement of the at least one animated figure component; and
coordinating, via the control system, the control of the motor assembly and the control of the at least one actuator to simulate a correspondence between the flight maneuver of the drone and the at least one movement of the at least one animated figure component.

19. The method of claim 18, wherein the flight maneuver includes an acceleration of the drone and the at least one movement of the at least one animated figure component includes an increase to a flapping rate of a wing corresponding to the at least one animated figure component.

20. The method of claim 18, wherein the flight maneuver includes a turning of the drone in a direction and the at least one movement of the at least one animated figure component includes a head or neck movement of a head or neck corresponding to the at least one animated component in the direction.
